(19) United States
(12) Patent Application Publication
(10) Pub. No.: US 2017/0187752 A1
(43) Pub. Date: Jun. 29, 2017

(54) Remote attestation and enforcement of hardware security policy

(71) Applicants: Steffen Schulz, Darmstadt (DE); Manoj R. Sastry, Portland, OR (US); Li Zhao, Beaverton, OR (US); Patrick Koeberl, Alsbach-Haenlein (DE)

(72) Inventors: Steffen Schulz, Darmstadt (DE); Manoj R. Sastry, Portland, OR (US); Li Zhao, Beaverton, OR (US); Patrick Koeberl, Alsbach-Haenlein (DE)

(21) Appl. No.: 14/998,084

(22) Filed: Dec. 24, 2015

(51) Int. Cl. H04L 29/06

(52) U.S. Cl. CPC H04L 63/20

(57) ABSTRACT

Systems, apparatuses and methods may provide for changing the execution mode of a device based on policy enforcement request that is received when the device is located proximately to a specific area. The policy enforcement request is verified with respect to a System on Chip (SoC) platform. An enforcement manager of the SoC platform may enforce the received policy enforcement request if verification is successful, and an attestation controller may report the enforced policy request and a status of the platform to an external device from which the policy request originates.

### BACKGROUND

Technical Field

Embodiments generally relate to remote attestation systems. More particularly, embodiments relate to a root of trust (RoT) that supports remote attestation of reported system events.

Discussion

In recent years, the use of video cameras and mobile communication devices such as laptops, smart phones, wearable devices and personal digital assistants (PDAs) devices has increased substantially.

This development may be a cause for concern in restricted areas such as top secret facilities where special restrictive measures are employed to prevent or minimize the entry of individuals into these areas. The use of cameras or other recording devices in the restricted facilities may result in the covert recording of information and images in the facility, thus compromising the integrity of the restricted facility and information contained therein.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example system on chip (SoC) platform according to embodiments;

FIG. 2 is a block diagram of an example microcontroller unit (MCU) of the SoC platform.

FIG. 3 is a block diagram of an example remote attestation scenario according to an embodiment;

FIG. 4 is a flow chart of an example method of performing remote attestation according to an embodiment;

FIG. 5 is a block diagram of an example of a processor according to an embodiment; and

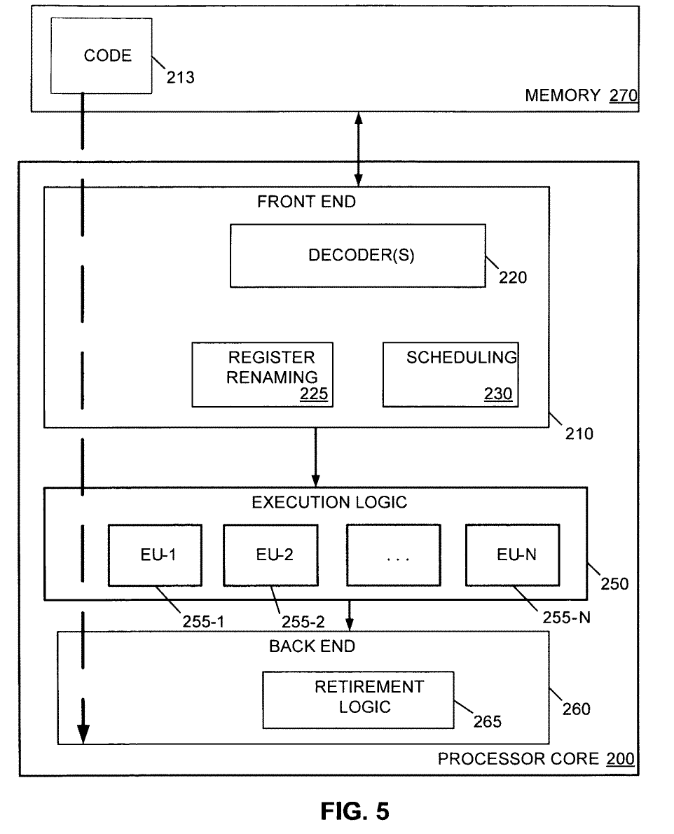

FIG. 6 is a block diagram of an example of a computing system according to an embodiment.

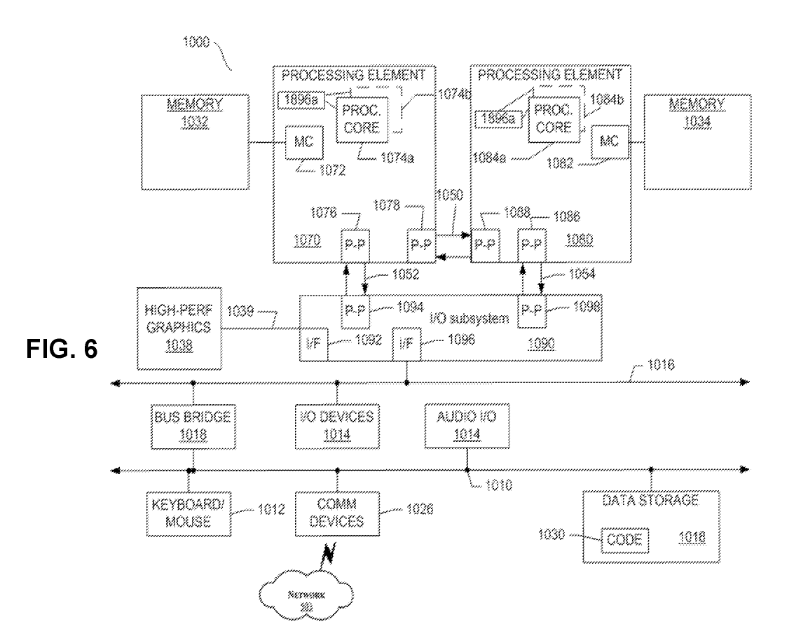

### DETAILED DESCRIPTION OF EXEMPLARY EMBODIMENTS

In embodiments of the present invention, a root of trust (RoT) to measure the hardware and software status of a platform and report the measurements is provided. The RoT not only supports remote attestation of supported system events, (e.g., typically the software chain of trust), but may also support the management of platform-specific configuration and status events such as, for example, platform capabilities, execution modes, and platform security policies. Additionally, a remote system may request changes to an execution mode or security policy of a device, which can be enforced using platform security mechanisms such as fabric access control tables, and in turn reported to the remote system.

The RoT may form the basis of trust for security purposes, and may be rooted in hardware and firmware mechanisms in client computing systems. From the RoT, the client computing system may construct a media processing pipeline that is protected for content authorization and verification.

In the following description, numerous specific details are set forth in order to provide a though understanding of the various embodiments. However, various embodiments may be practiced without the specific details. In other instances, well-known methods, procedures, components, and circuits have not been described in detail so as not to obscure the particular embodiments of the invention. Further, various aspects of the embodiments may be performed using various means such as integrated semiconductor circuits (hardware); computer-readable instructions organized into one or more programs stored on a computer readable storage medium (software), or some combination of hardware and software.

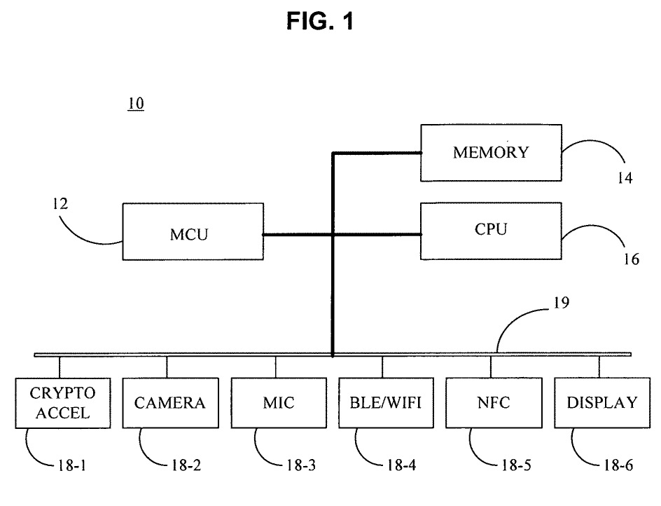

Turning now to FIG. 1, a high level view of a system on chip (SoC) platform 10 with various integrated input/output (I/O) components is illustrated. The illustrated SoC platform 10 includes a microcontroller unit (MCU) 12, a memory module 14, a host processor 16 (e.g., central processing unit/CPU), and platform components 18-1 to 18-6 coupled to an SoC bus 19.

The SoC bus 19 may distinguish transactions between the MCU 12 and the platform components 18-1 to 18-6 based on an initiating bus master (agent) (not shown). Such an approach may enable a low-level access control and partitioning of the SoC components 18-1 to 18-6 based on the individual usage and security requirements of each component. The SoC platform components may include, but are not limited to, a cryptographic accelerator 18-1, a camera 18-2, a microphone 18-3, a Bluetooth or Wireless Fidelity (WiFi) device 18-4 (e.g., Bluetooth Low Energy/BLE or other wireless enabled device), a device capable of performing near field communication (NFC) 18-5, and a display device 18-6.

An increasing configurability and integration of various components and features into SoCs may lead to a more flexible and lower cost security core, which may also include a security policy. By including a RoT for measurement and attestation, the capabilities of SoCs may be extended to become a visible and useful security feature of platforms. The exemplary embodiments implement remote attestation in the MCU 12, and extend the capability to encompass hardware security policies of the platform 10. The MCU 12 may also support the interaction of the platform 10 with external sources by using additional protocols to negotiate and process changes to hardware security policies, and to locally enforce a committed policy.

The illustrated MCU 12 manages an access control enforced by the SoC bus 19 and interacts with individual platform components connected to the SoC bus 19. This management and interaction may enable the MCU 12 to dynamically control the flow of information on the SoC bus 19, and control the individual components 18-1 to 18-6. The MCU 12 may further support remote attestation by authenticating platform measurements of hardware and software configurations and reporting of the configuration platform values. The MCU 12 may also support the currently enforced SoC bus access policy and the status of individual components. Accordingly, a remote source may be able to verify the integrity of the platform components and the enforced platform security policy and hardware status of the individual components.

Remote attestation may be performed using trusted platform modules (TPMs), which maintain a log of the software state of the device. The log may be extended with information related to the hardware platform, such as firmware version information, and the executing of authenticated code modules (ACMs) in a different TPM locally.

The TPM may be a hardware component in the form of a dedicated integrated circuit built into a variety of platforms. The TPM, which may be equipped with an anti-tampering capability, may provide secure storage for digital keys, certificates and passwords, as well as functionality for various security-related operations such as key generation, platform attestation, privacy protection functions and implementation of cryptographic algorithms and protocols.

According to an exemplary embodiment, the attestation capabilities of the platform are extended to hardware security policies such as access control on the platform bus. A platform security core may report the availability and status of fundamental platform capabilities, adjust the hardware policies based on requests from an operating system or external entities, and attest to the enforcement of such requests until subsequent requests are received, or until a contextual event or timeout occurs.

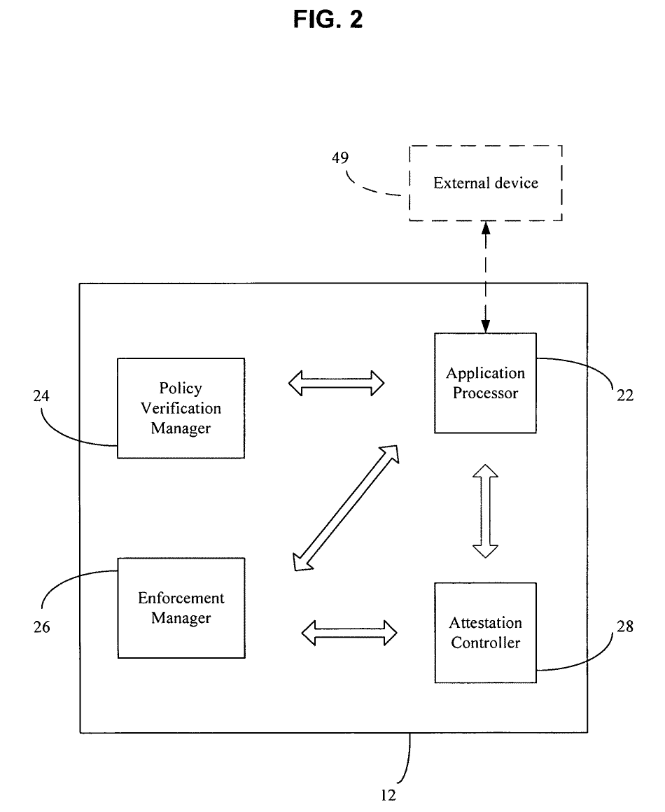

Turning now to FIG. 2, a detailed view of an MCU such as, for example, the MCU 12 (FIG. 1) of the SoC platform 10 (FIG. 1) is illustrated. An application processor 22 of the MCU 12 may obtain a request from an external source 49, wherein the request may include a policy enforcement request (discussed below). The MCU 12 may communicate with various devices such as, for example, a laptop computer, a notebook computer, a tablet computer, a convertible tablet, a personal digital assistant (PDA), a mobile internet device (MID), wearable computers, a smart phone, a camera, a camcorder, a media player, etc., or any combination thereof).

The policy enforcement request may include a request from an external device 49 to disable an SoC component such as, for example, a camera or microphone, before the SoC component enters a sensitive or restricted area. The policy enforcement request may also include a request to enforce the authentication of audio and/or video recordings while the SoC component is used at a place of employment (e.g., in a testing and/or maintenance facility), or to enforce the encryption of audio and/or video recordings so that an approval process for releasing such recordings may be cryptographically enforced. The policy enforcement request may also be used to adjust the exposure and/or security status of the SoC component, based on the current situation, such as to require sensitive devices to stop accepting new connections or inputs when they leave a designated safe area. Devices may also be requested to, for example, refrain from taking pictures of individuals or objects in a restricted area, or react to recognized objects or gestures in a certain manner.

As already noted, the policy request may include a policy enforcement request that is transmitted and/or broadcasted from the external source 49. The application processor 22 may request the device owner to confirm the enforcement of the requested policy. The policy request may then be forwarded to a policy verification manager 24 of the MCU 12. The policy verification manager 24 may conduct additional verifications of the policy request such as matching the requested policy against a local established base policy. The local established base policy may be set by the device manufacturer, or alternately, may be set by the owner of the device. The MCU 12 may also authenticate the origin of the request in order to ascertain that the request is being received from a legitimate source. An enforcement manager 26 of the MCU 12 may then authorize and enforce the requested policy or a modified subset of the requested policy using privileged SoC bus access rights if the verification is successful.

The MCU 12 may then interpret the current platform status and the enforced access control policy as logical state information that is input to the remote attestation procedure. The platform hardware/software status may be determined and reported to the application processor 22, which in turn forwards the hardware/software status to the external source 49 that transmitted the policy request. Alternately, the platform hardware/software status may be determined and reported to an attestation controller 28, which in turn forwards the hardware/software status to the external source 49 that transmitted the policy request.

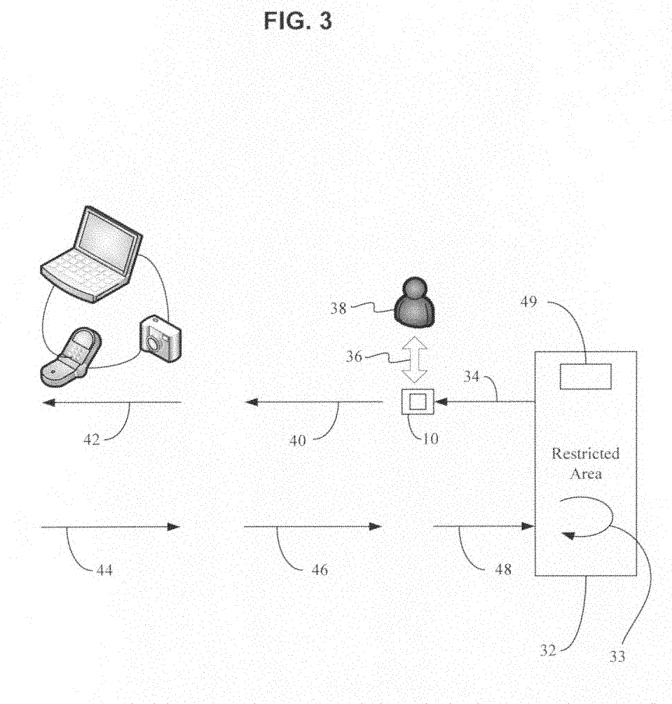

Turning now to FIG. 3, an exemplary policy enforcement and remote attestation flow is illustrated. In the illustrated exemplary embodiment, the external device 49 may be located in a restricted or access-controlled area 32. As an example, the external device 49 may be an integral part of a building access control system. At a point of entry of the restricted area 32, a user 38 may opt in to conduct the policy enforcement. However, this is only exemplary, and the policy enforcement process may be automatically conducted when the user 38 is within a predetermined radius of the restricted area.

The external device 49 is not limited to a building access control system. The exemplary embodiments may also be applied to areas where there is a need to limit or control the ability of devices to communication or function. For example, the exemplary embodiments may limit the ability of devices to communicate in restricted areas such as hospital examination rooms, airports, and airplanes. The exemplary embodiments may also limit the ability of devices to perform recording functions in sensitive sites on in confidential meetings. The exemplary embodiments may also enforce authenticated and encrypted recordings as a security log when performing critical operations in the context of manufacturing, maintenance, or incident reporting.

Returning to FIG. 3, after the user 38 has opted into the policy enforcement process (36), or upon the policy enforcement process being automatically activated, the external device 49, which may be located in the restricted area 32, may transmit or broadcast 34 a policy enforcement request to the SoC platform 10. The message may be received by the policy verification manager 24 (FIG. 2), which verifies the policy enforcement request by matching the requested policy against a local established base policy. If the policy enforcement request is verified, the enforcement manager 26 (FIG. 2) enforces 40 the policy. The enforcement of the policy may include disabling 42 various functions of the platform component prior to the platform component entering the restricted area 32. The platform component may then be inspected 44 to conform that the various functions have been disabled, and the current platform status and the enforced access control policy may be interpreted 46 as a report and forwarded 48 to the external device 49. The illustrated external device 49 verifies the reported current platform status and the enforced access control policy with an internally defined policy 33. The external device 49 may then perform one or more operations based on a result of the verification process. The operation(s) may include admitting the platform component into the restricted area 32 or requesting that the platform component be disabled or contained.

Once the requested policies are enforced, they may remain locked or in force until a defined event or set of events occurs. Examples of events that may revert or unlock a currently enforced policy include a specific message being issued from the external source; a timer expiring; or a request from a specific trusted initiator on the SoC fabric being received. Policy enforcement may be persistent across SoC power cycles or resets.

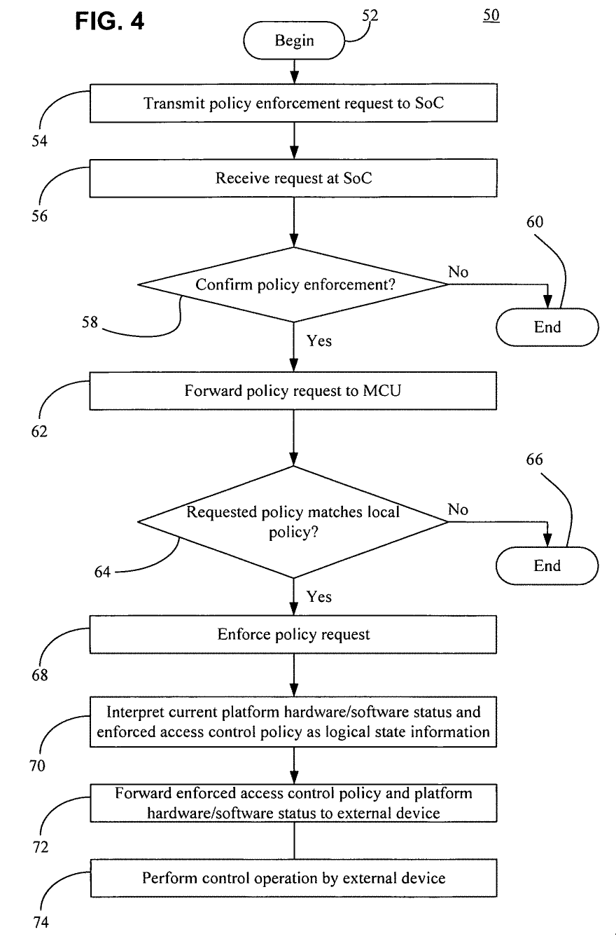

FIG. 4 shows a method 50 of conducting a policy enforcement request according to an exemplary embodiment. One or more aspects of the method 50 may generally be implemented in a SoC platform such as, for example, the SoC platform 10 (FIG. 1). More particularly, the method 50 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 50 may be written in any combination of one or more programming languages, including an object oriented programming language such as JAVA, SMALLTALK, C++ or the like and conventional procedural programming languages, such as the “C” programming language or similar programming languages.

The illustrated method 50 begins at block 52. In processing block 56, the SoC platform receives a policy enforcement request that is transmitted from an external device in processing block 54. Block 56 may include receiving the policy enforcement request at an application processor of the SoC. In processing block 58, the application processor may confirm that the user of a device coupled to the SoC wishes to proceed with the enforcement of the policy request. If the device user does not wish to proceed with the enforcement of the policy request, the illustrated method 50 terminates at block 60. The termination of the process at block 60 may result in a refusal of admission of the device to a restricted facility.

On the other hand, if the device user wishes to proceed with the enforcement of the policy, the policy enforcement request may be forwarded to a policy verification manager of an MCU at block 62. At block 64, the requested policy is matched to a local established base policy that is set by the user or the manufacturer of the device. If it is determined at block 64 that the requested policy does not match the local established base policy, the illustrated method 50 terminates at block 66. Otherwise, at block 68, an enforcement manager of the MCU may enforce the policy request. Illustrated block 70 interprets the current platform status and the enforced access control policy as logical state information that is input to the remote attestation procedure. At block 72, the platform status and the enforced access control policy may be transmitted to the external device. At block 74, the external device verifies the reported platform status and enforced access control policy, and either admits the device to the restricted area or denies admission to the device based on the content of the reported platform status and enforced access control policy.

### Additional Notes and Examples

Example 1 may include a policy verification system comprising a communication interface; a plurality of platform components including one or more of a cryptographic accelerator, a camera, a microphone, a near-field communication (NFC) device, or a display; a policy verification manager to conduct a verification of a policy request with respect to a platform; an enforcement manager to enforce the policy request if the verification is successful; and an attestation controller to report, via the communication interface, the enforced policy request and a status of one or more of the plurality of platform components to a remote device, wherein the policy request is to originate from the remote device.

Example 2 may include the system of claim 1, further comprising a processor to control one or more SoC components on the platform.

Example 3 may include the system of claim 2, wherein the processor is to disable at least one of the one or more SoC components based on a result of the verification.

Example 4 may include the system of claim 1, wherein conducting the verification includes determining whether the policy request complies with a local base policy.

Example 5 may include the system of claim 1, further comprising a processor to apply a root of trust to a communication containing the enforced policy request.

Example 6 may include the system of any one of claims 1 to 5, wherein the policy request is to identify one or more of an execution mode change or a requested security policy change.

Example 7 may include the system of Example 1, wherein the remote device is integrated into one or more of a building access control system and a restricted area.

Example 8 may include a policy verification apparatus comprising a policy verification manager to conduct a verification of a policy request with respect to a platform; an enforcement manager to enforce the policy request if the verification is successful; and an attestation controller to report the enforced policy request and a status of the platform to a remote device, wherein the policy request is to originate from the remote device.

Example 9 may include the apparatus of claim 8, further comprising a processor to control one or more System on Chip (SoC) components on the platform.

Example 10 may include the apparatus of claim 9, wherein the processor is to disable at least one of the one or more SoC components based on a result of the verification.

Example 11 may include the apparatus of claim 8, wherein conducting the verification includes determining whether the policy request complies with a local base policy.

Example 12 may include the apparatus of claim 8, further comprising a processor to apply a root of trust to a communication containing the enforced policy request.

Example 13 may include the apparatus of any one of claims 8 to 12, wherein the policy request is to identify one or more of an execution mode change or a requested security policy change.

Example 14 may include the apparatus of example 8, wherein the remote device is integrated into one or more of a building access control system and a restricted area.

Example 15 may include a policy verification method comprising conducting a verification of a policy request with respect to a platform; enforcing the policy request if the verification is successful; and reporting the enforced policy request and a status of the platform to a remote device, wherein the policy request originates from the remote device.

Example 16 may include the method of claim 15, further comprising applying a root of trust to a communication containing the enforced policy request.

Example 17 may include the method of any one of claims 15 to 16, wherein the policy request identifies one or more of an execution mode change or a requested security policy change.

Example 18 may include at least one computer readable storage medium comprising a set of instructions, which when executed by an apparatus, cause the apparatus to: conduct a verification of a policy request with respect to a platform; enforce the policy request if the verification is successful; and report the enforced policy request and a status of the platform to a remote device, wherein the policy request is to originate from the remote device.

Example 19 may include the at least one computer readable storage medium of claim 18, wherein the instructions, when executed, cause the apparatus to control one or more System on Chip (SoC) components on the platform.

Example 20 may include the at least one computer readable storage medium of claim 19, wherein the instructions, when executed, cause the apparatus to disable at least one of the one or more SoC components based on a result of the verification.

Example 21 may include the at least one computer readable storage medium of claim 18, wherein conducting the verification includes determining whether the policy request complies with a local base policy.

Example 22 may include the at least one computer readable storage medium of claim 18, wherein the instructions, when executed, cause the apparatus to apply a root of trust to a communication containing the enforced policy request.

Example 23 may include the at least one computer readable storage medium of any one of claims 18 to 22, wherein the policy request identifies one or more of an execution mode change or a requested security policy change.

Example 24 may include the at least one computer readable storage medium of claim 18, wherein the remote device is integrated into one or more of a building access control system and a restricted area.

Example 25 may include a policy verification apparatus comprising means for conducting a verification of a policy request with respect to a platform; means for enforcing the policy request if the verification is successful; and means for reporting the enforced policy request and a status of the platform to a remote device; wherein the policy request originates from the remote device.

Example 26 may include the apparatus of claim 25, further comprising means for controlling one or more System on Chip (SoC) components on the platform.

Example 27 may include the apparatus of claim 26, further comprising means for disabling at least one of the one or more SoC components based on a result of the verification.

Example 28 may include the apparatus of claim 25, wherein the means for conducting the verification includes means for determining whether the policy request complies with a local base policy.

Example 29 may include the apparatus of claim 25, further comprising means for applying a root of trust to a communication containing the enforced policy request.

Example 30 may include the apparatus of claim 25, wherein the means for enforcing the policy request identifies one or more of an execution mode change and a requested security policy change.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A system comprising:
a communication interface;
a plurality of platform components including one or more of a cryptographic accelerator, a camera, a microphone, a near-field communication (NFC) device, or a display;
a policy verification manager to conduct a verification of a policy request with respect to a platform;
an enforcement manager to enforce the policy request if the verification is successful; and
an attestation controller to report, via the communication interface, the enforced policy request and a status of one or more of the plurality of platform components to a remote device, wherein the policy request is to originate from the remote device.

2. The system of claim 1, further comprising a processor to control one or more SoC components on the platform.

3. The system of claim 2, wherein the processor is to disable at least one of the one or more SoC components based on a result of the verification.

4. The system of claim 1, wherein conducting the verification includes determining whether the policy request complies with a local base policy.

5. The system of claim 1, further comprising a processor to apply a root of trust to a communication containing the enforced policy request.

6. The system of claim 1, wherein the policy request is to identify one or more of an execution mode change or a requested security policy change.

7. The system of claim 1, wherein the remote device is integrated into one or more of a building access control system and a restricted area.

8. An apparatus comprising:
a policy verification manager to conduct a verification of a policy request with respect to a platform;
an enforcement manager to enforce the policy request if the verification is successful; and
an attestation controller to report the enforced policy request and a status of the platform to a remote device, wherein the policy request is to originate from the remote device.

9. The apparatus of claim 8, further comprising a processor to control one or more System on Chip (SoC) components on the platform.

10. The apparatus of claim 9, wherein the processor is to disable at least one of the one or more SoC components based on a result of the verification.

11. The apparatus of claim 8, wherein conducting the verification includes determining whether the policy request complies with a local base policy.

12. The apparatus of claim 8, further comprising a processor to apply a root of trust to a communication containing the enforced policy request.

13. The apparatus of claim 8, wherein the policy request is to identify one or more of an execution mode change or a requested security policy change.

14. The apparatus of claim 8, wherein the remote device is integrated into one or more of a building access control system and a restricted area.

15. A method comprising:
conducting a verification of a policy request with respect to a platform;
enforcing the policy request if the verification is successful; and
reporting the enforced policy request and a status of the platform to a remote device, wherein the policy request originates from the remote device.

16. The method of claim 15, further comprising applying a root of trust to a communication containing the enforced policy request.

17. The method of claim 15, wherein the policy request identifies one or more of an execution mode change or a requested security policy change.

18. At least one computer readable storage medium comprising a set of instructions, which when executed by an apparatus, cause the apparatus to:
conduct a verification of a policy request with respect to a platform;
enforce the policy request if the verification is successful; and
report the enforced policy request and a status of the platform to a remote device, wherein the policy request is to originate from the remote device.

19. The at least one computer readable storage medium of claim 18, wherein the instructions, when executed, cause the apparatus to control one or more System on Chip (SoC) components on the platform.

20. The at least one computer readable storage medium of claim 19, wherein the instructions, when executed, cause the apparatus to disable at least one of the one or more SoC components based on a result of the verification.

21. The at least one computer readable storage medium of claim 18, wherein conducting the verification includes determining whether the policy request complies with a local base policy.

22. The at least one computer readable storage medium of claim 18, wherein the instructions, when executed, cause the apparatus to apply a root of trust to a communication containing the enforced policy request.

23. The at least one computer readable storage medium of claim 18, wherein the policy request identifies one or more of an execution mode change or a requested security policy change.

24. The at least one computer readable storage medium of claim 18, wherein the remote device is integrated into one or more of a building access control system and a restricted area.
